(19) United States
(12) Patent Application Publication
(10) Pub. No.: US 2024/0286883 A1
(43) Pub. Date: Aug. 29, 2024

(54) PORTABLE BEVERAGE DISPENSING DEVICE AND METHOD THEREOF

(71) Applicant: HCL Technologies Limited, New Delhi (IN)

(72) Inventors: MOHAN SRIRAM, Bengaluru (IN); VISHWANATH VAZAR, Bengaluru (IN); YUVARAJ D PATIL, Bengaluru (IN); PUNITH KUMAR DN, Bengaluru (IN); VINODARAJA N, Bengaluru (IN); SOURABH SATTAPPA KSHIRSAGAR, Bengaluru (IN); Kaoshal U Minajigi, Bengaluru (IN)

(21) Appl. No.: 18/422,044

(22) Filed: Jan. 25, 2024

(30) Foreign Application Priority Data
Feb. 24, 2023 (IN) 202311012717

(51) Int. Cl. B67D 1/00; B67D 1/08

(52) U.S. Cl. CPC B67D 1/008; B67D 1/0871; B67D 2210/00044; B67D 2210/00086; B67D 2210/00131

(57) ABSTRACT

A portable beverage dispensing device is disclosed. In some embodiments, the portable beverage dispensing device includes a container and a dispensing mechanism. The container includes a set of beverage holders, a pressurized gas holder, and a plurality of cap assemblies. Each of the set of beverage holders is configured to hold a beverage bottle. The pressurized gas holder is configured to hold a pressurized gas vessel. Further, each of the plurality of cap assemblies includes a cork. The cork further includes an inlet port connected via a gas tube to the pressurized gas vessel to receive a pressurized gas, and an outlet port for dispensing a beverage filled within the beverage bottle. The dispensing mechanism includes a dispensing head. The dispensing head further includes a set of dispensing ports and a set of dispensing buttons configured to initiate dispensing of a beverage through an associated dispensing port.

### TECHNICAL FIELD

Generally, the invention relates to beverage dispenser. More specifically, the invention relates to portable beverage dispensing device and method thereof.

### BACKGROUND

Beverages like juice and carbonated drinks are often consumed by people in their everyday life. In order to get the most flavor and taste from these beverages, especially carbonated drinks, it is ideal to consume these beverages cold with optimum maintained fizziness. Further, to provide these beverages to consumers especially in crowded places like multiplexes, stadiums, and mega events, either beverage dispensers (e.g., fountain dispensers) are installed or severed via refrigerated pet bottles.

Moreover, in order to serve the beverage at a seat or a location of the consumers, the seller needs to carry beverage bottles or a glass containing dispensed beverage to the seat of the consumer. During serving of the beverages via the beverage bottles or in the glass, the beverage may gain temperature and become warm, thereby losing its fizziness. This may result in reduced taste sensory experience to consumers. Hence, there is a problem in currently used serving methods of such beverages that are delivered or sold to consumer at the point of consumption, i.e., their respective seats in places like movie theater, stadium, etc.

Therefore, there is a need of efficient portable beverage dispensing device for serving beverages at a location of a consumer without losing fizziness of the beverage being served.

### SUMMARY OF INVENTION

In one embodiment, a portable beverage dispensing device is disclosed. The portable beverage dispensing device may include a container. The container may include a set of beverage holders. It should be noted that, each of the set of beverage holders may be configured to hold a beverage bottle. The container may further include a pressurized gas holder configured for holding a pressurized gas vessel filled with a pressurized gas. The container may further include a plurality of cap assemblies. It should be noted that, a cap assembly from the plurality of assemblies may include a cork configured to fit on an opening of the beverage bottle. The cork may include an inlet port connected via a gas tube to the pressurized gas vessel and configured to receive the pressurized gas from the pressurized gas vessel into the beverage bottle. The cork may further include an outlet port for dispensing a beverage filled within the beverage bottle in response to receiving the pressurized gas. The portable beverage dispensing device may further include a dispensing mechanism configured to dispense the beverage filled within the beverage bottle. The dispensing mechanism may further include a dispensing head. The dispensing head may include a set of dispensing ports. It should be noted that, a dispensing port from the set of dispensing ports may be connected via a dispensing tube to the outlet port of the beverage bottle. The dispensing head may further include a set of dispensing buttons configured to initiate dispensing of a beverage through an associated dispensing port. It should be noted that, activation of a dispensing button from the set of dispensing buttons is configured to release pressure from the pressurized gas vessel into the beverage bottle via the inlet port; release the beverage from the outlet port to the dispensing port via the dispensing tube; and dispense the beverage from the dispensing port.

In another embodiment, a cap assembly for beverage bottles is disclosed. The cap assembly may include a cork, an inner sleeve, and an outer sleeve. The cork may include a first end, an intermediate cylindrical surface, and a second end. The first end may include an outlet port configured to receive a tube; and dispense a beverage from within a beverage bottle via the tube. The intermediate cylindrical surface may include an inlet port configured to receive a pressurized gas from a pressurized gas vessel via a gas tube. It should be noted that, the intermediate cylindrical surface may be positioned between the first end and the second end. In addition, the second end may include a plurality of grooves, and O-rings cooperating with the plurality of grooves. The second end of the cork may be attached to the inner sleeve via a collar. Further, the inner sleeve may include a plurality of spherical metal balls and a spring. The inner sleeve and the outer sleeve may be assembled with each other via the plurality of spherical metal balls and the spring. In addition, the outer sleeve may be configured to move relative to the inner sleeve between a up position and a down position to put the cork in a locked state or an unlocked state at an opening of the beverage bottle.

In yet another embodiment, a method for providing beverage at a location of a user is disclosed. The method may include rendering to a user, a list of a plurality of beverages within each of a portable beverage dispensing device. It should be noted that, the list may include a type of each of the plurality of beverages, an amount of each of the plurality of beverages, and a plurality of attributes associated with each of the plurality of beverages. In addition, the location of the user may be within a pre-defined range of each of the portable beverage dispensing device. The method may further include receiving from the user, a command associated with at least one of the plurality of beverages within one of the portable beverage dispensing device in response to rendering. It should be noted that, the command may include a request to provide the at least one of the plurality of beverages at the location of the user and one or more of the plurality of attributes selected by the user corresponding to at least one of the plurality of beverages. The method may further include displaying to the user, a confirmation message for providing the at least one of the plurality of beverages at the location of the user in response to receiving the command.

In yet another embodiment, a method for establishing communication for providing beverages at a user location is disclosed. The method may include receiving, by a server, a command associated with at least one of a plurality of beverages within at least one of a portable beverage dispensing device available within a pre-defined range of a user location. It should be noted that, the command may include a request to provide the at least one of the plurality of beverages at the user location and one or more of a plurality of attributes selected by the user corresponding to the at least one of the plurality of beverages. The method may further include transmitting, by the server to at least one of the portable beverage dispensing device, the command associated with the at least one of the plurality of beverages. The method may further include receiving, by the server from the at least one of the portable beverage dispensing device, a confirmation message for providing the at least one of the plurality of beverages at the user location with fulfilment of the one or more of the plurality of attributes. The method may further include transmitting, by the server, the confirmation message to a user device.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIGS. 1A and FIG. 1B is a pictorial representation of an outside look of a portable beverage dispensing device, in accordance with an exemplary embodiment.

FIGS. 2A and 2B is a pictorial representation of an inner cavity view and a thermal insulation layer of a portable beverage dispensing device, in accordance with an exemplary embodiment.

FIGS. 3A-3C is a pictorial representation of a container present within a portable beverage dispensing device, in accordance with an exemplary embodiment.

FIG. 4 illustrates a connection of a plurality of beverage bottles with a pressurized gas vessel and a dispensing mechanism, in accordance with an exemplary embodiment.

FIG. 5 is a pictorial representation of a pressurized gas vessel, in accordance with an exemplary embodiment.

FIGS. 6A-6C is a pictorial representation of a cap assembly configured to fit on a beverage bottle, in accordance with an exemplary embodiment.

FIG. 7 is a pictorial representation of a dispensing mechanism, in accordance with an exemplary embodiment.

FIG. 8 illustrates a flow diagram of a method for providing beverage at a location of a user, in accordance with an embodiment.

FIG. 9 illustrates a flowchart of a method for establishing communication for providing beverages at a user location, in accordance with an embodiment.

FIG. 10 illustrates an exemplary environment diagram for providing beverage at a location of a user, in accordance with an exemplary embodiment.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

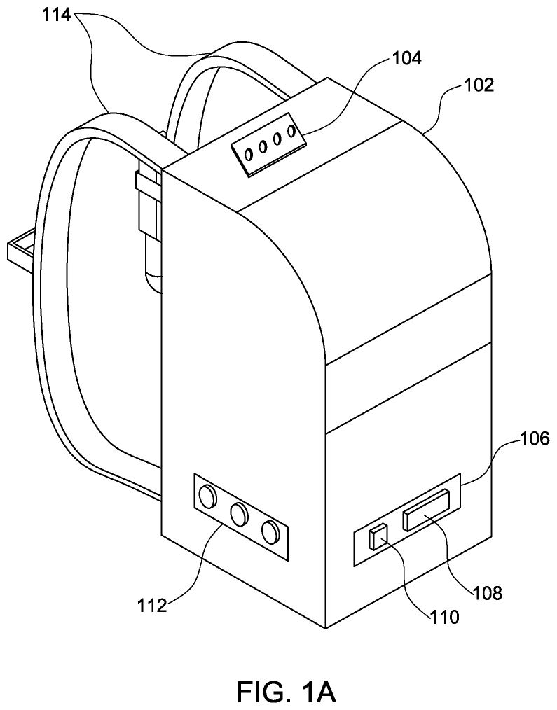

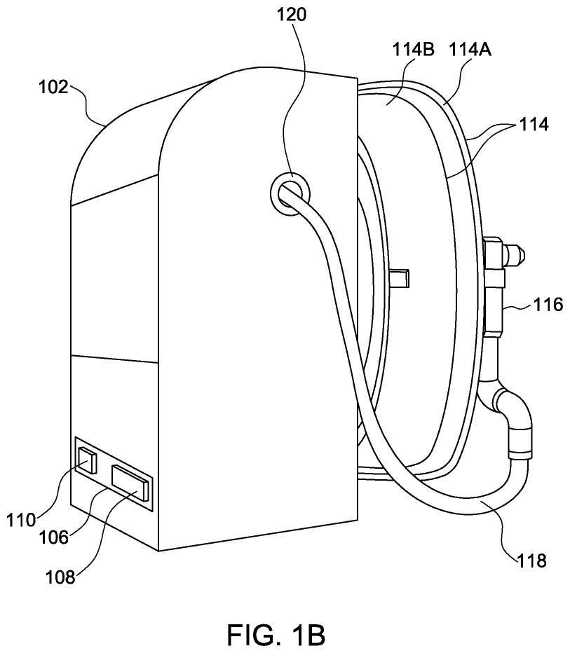

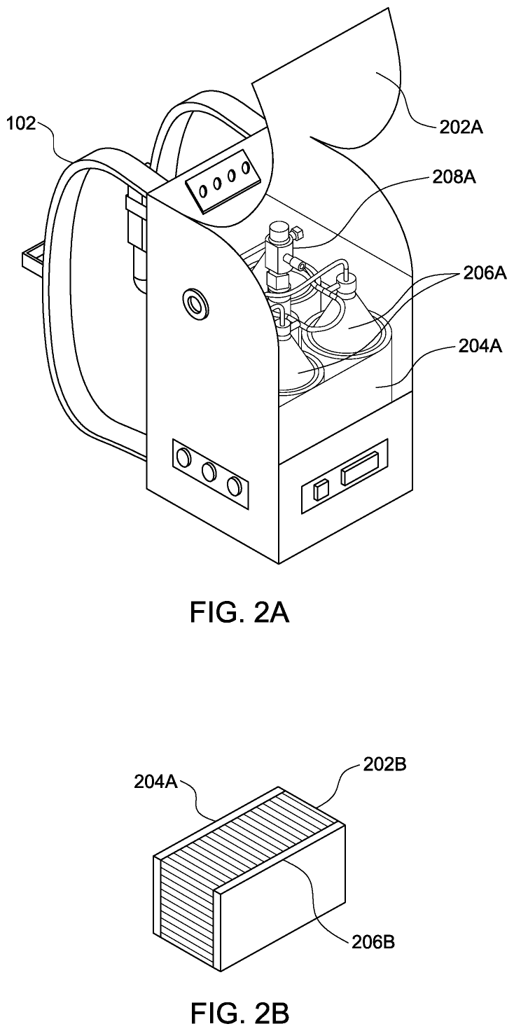

Referring now to FIGS. 1A and 1B, a pictorial representation of an outside look of a portable beverage dispensing device 102 is depicted, in accordance with an exemplary embodiment. In the FIG. 1A, an isometric view of the portable beverage dispensing device 102 is depicted. The portable beverage dispensing device 102 may be configured to provide beverage at a location of a user (i.e., a consumer). The portable beverage dispensing device 102 may be a portable backpack, as depicted via the present FIG. 1. Further, the portable beverage dispensing device 02 may include a thermal insulation layer. The thermal insulation layer may be configured to create a thermally insulated cavity inside the portable beverage dispensing device 102. The created thermally insulated cavity may reduce heat movements and vapor condensations, thereby maintaining a low ambient temperature within the portable beverage dispensing device 102. This is further shown and explained in conjunction with FIG. 2B.

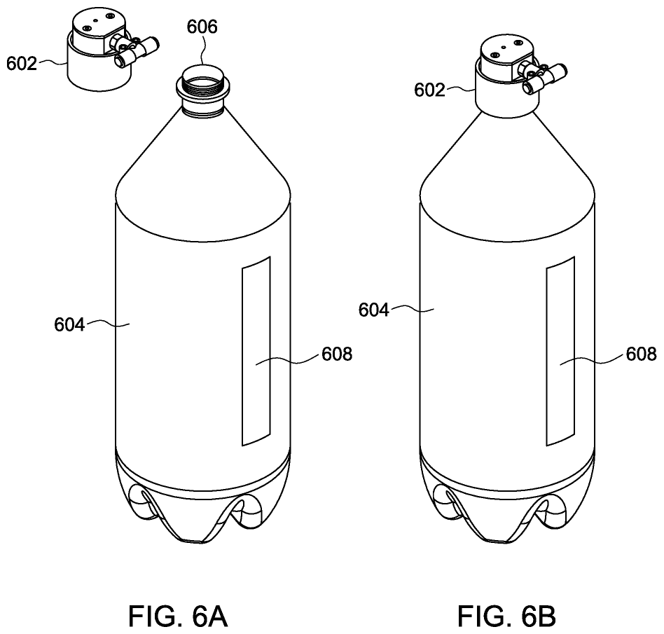

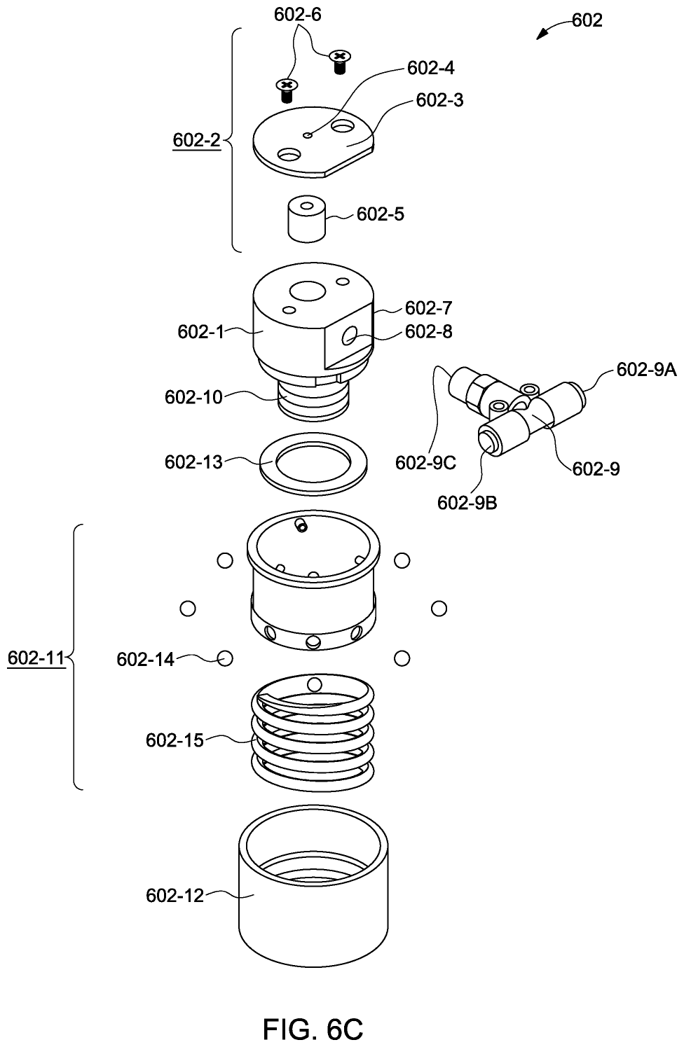

The portable beverage dispensing device 102 may include a container. The container may include a set of beverage holders, a pressurized gas holder, and a plurality of cap assemblies. In an embodiment, each of the set of beverage holders is configured to hold a beverage bottle. The pressurized gas holder may be configured for holding a pressurized gas vessel. The pressurized gas vessel may be filled with a pressurized gas, e.g., Carbon dioxide (CO₂). The container including the set of beverage holders and the pressurized gas vessel holder is shown and explained in detail with reference to 3A to 3C. Further, each of the plurality of cap assemblies may include a cork. The cork may be configured to fit on an opening of the beverage bottle. The cap assembly including the cork is further depicted and explained in conjunction with FIG. 6A to 6C.

Further, as depicted via the present FIG. 1A, the portable beverage dispensing device 102 may further include a communication system 104. The communication system 104 may be an in-built communication system. The communication system 104 may include an interactive display 106, a communication module (not shown), a plurality of sensors, and a central controller 108. In an embodiment, the interactive display 106 may be configured to display attributes associated with beverage present within the beverage bottle. By way of example, the attributes associated with the beverage within the beverage bottle may include a level of beverage within the beverage bottle present within each of the set of beverage bottle holders, temperature of the beverage within each beverage bottle, and the like.

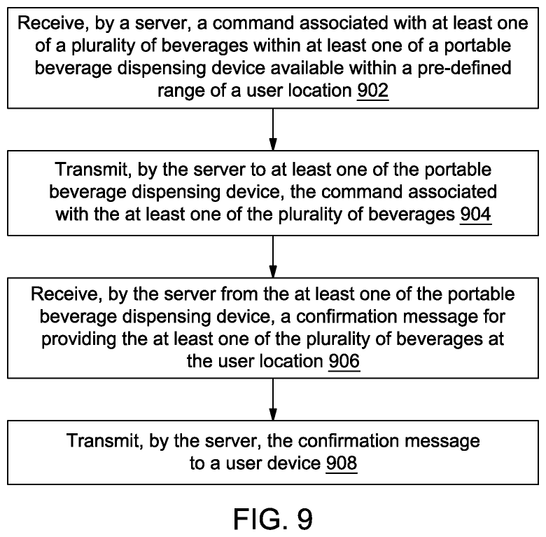

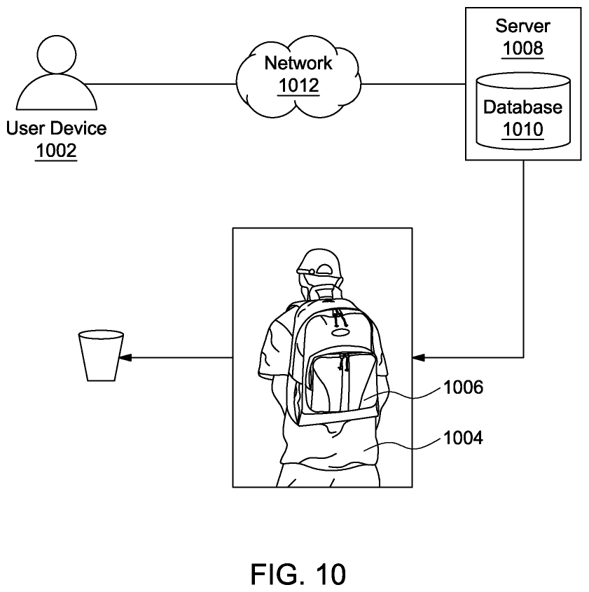

Further, the communication module may be configured to receive command from the user corresponding to the beverage present within the beverage bottle. In embodiment, the communication module may receive the command from the user present within a pre-defined range, for providing the beverage at a location of the user, via a user device. By way of an example, the pre-defined range for the portable beverage dispensing device 102 may be defined to be within ‘15 kilometers (kms) range. In other words, the portable beverage dispensing device 102 may provide the beverage to the user that is present within the range of 15 kms of the portable beverage dispensing device 102. As will be appreciated, the portable beverage dispensing device 102 may be carried by a seller to provide the beverage at the location of the user, upon receiving the command. A method of providing the beverage at the location of the user is further explained in detail in conjunction with FIG. 9 and FIG. 10.

Further, each of the plurality of sensors may be configured to generate a signal based on data captured by each of the plurality of sensors. In an embodiment, the plurality of sensors may include a set of pressure sensors, a set of beverage level sensors, and a set of temperature level sensors. By way of example, one or more of the set of pressure level sensors may be configured measure level of the pressurized gas in the pressurized gas vessel. In some embodiment, one or more of the set of pressure level sensors may be configured to measure level of the pressurized gas in each beverage bottle present within each of the set of beverage bottle holder. Further, the set of beverage level sensors may be configured to measure the level of the beverage present within each beverage bottle present within each of the set of beverage bottle holders. In addition, one or more of the set of temperature level sensors may be configured to measure the temperature of the beverage present with each beverage bottle. Further, the one or more of the set of temperature level sensors may be configured to measure a change in temperature within the portable beverage dispensing device 102.

Further, the central controller 108 may be configured to receive the generated signal form each of the plurality of sensors. In an embodiment, the central controller 108 may be configured for generating a trigger based on the received signal. In an embodiment, the trigger may be at least one of: replace the beverage bottle, re-fill the pressurized gas in the pressurized gas vessel, change at least one of the one or more replaceable cold gel packs, and rise in temperature of the beverage filled within the beverage bottle. In addition to generating the trigger, the central controller 108 may be configured to perform an action based on the command received from the user corresponding to the beverage present within the beverage bottle. By way of an example, when the central controller 108 receives a signal from a beverage level sensor associated with the beverage bottle that includes data of the level of beverage in the beverage bottle, for example, “level of the beverage 100 ml”, then the central controller 108 may be configured to the trigger. The trigger may be, for example, replace the beverage bottle.

In addition, to the communication system 104, the portable beverage dispensing device 102 may also include a cooling mechanism. The cooling mechanism (not shown in figures) may be configured to maintain temperature of the beverage filled within the beverage bottle. In order to maintain temperature of the beverage within the beverage bottle, the cooling mechanism may include an insulation sheet for insulating the container, a fan, and one or more replaceable cold gel packs. In an embodiment, the fan may be housed in a top portion of the portable beverage dispensing device 102, in a way, such that the fan will receive air from an outer surface of the top portion of the portable beverage dispensing device 102. The outer surface of the top portion of the portable beverage dispensing device 102 may include air vents for receiving air inside the top portion.

The fan may be configured to receive air from the air vents and push the received air towards bottom portion of the portable beverage dispensing device 102. Further, the bottom portion of the portable beverage dispensing device 102 may include the one or more replaceable gel packs. Further, the fan may be connected to the central controller 108. The central controller 108 may be configured to vary speed of the fan upon receiving the signal for rise in temperature of the beverage within the beverage bottle. In some embodiment, the fan may be operated by the central controller 108 via a battery 110 electrically connected to the central controller 108. The battery may be a rechargeable battery. In an embodiment, when the fan is on, the fan may pass air from each of the one or more replaceable cold gel pack. By way of an example, when the central controller 108 may receive the signal including an indication of rise in the temperature within the portable beverage dispensing device 102. Then, the central controller 108 may generate the trigger to increase the speed of the fan. In addition, upon receiving the signal for rise in temperature, the central controller 108 may generate the trigger for replacing the one or more replaceable cold gel packs.

In addition to the cooling mechanism, the portable beverage dispensing device 102 may further include a touch screen 112. The touch screen 112 may include a set of three clickable buttons, as depicted via the present FIG. 1A. Each of the set of three buttons may be configured to select an amount of the beverage to be dispensed. For example, first button from the set of three buttons may be for dispensing ‘250 ml’ of the beverage. Second button may be for dispensing 500 ml of the beverage. Lastly, the third button may for dispensing 750 ml of the beverage. In some embodiment, the user may manually enter the amount of beverage to be dispensed via the touch screen 110. In some another embodiment, the touch screen 110 may not be present and the user may select the amount of the beverage via the interactive display 106. As discussed above, in the present FIG. 1A, the portable beverage dispensing device 102 may be the portable backpack. Further, as depicted via the present FIG. 1A, the portable backpack may include shoulder straps 114. The shoulder straps 114 may enable the seller to conveniently carry the portable backpack.

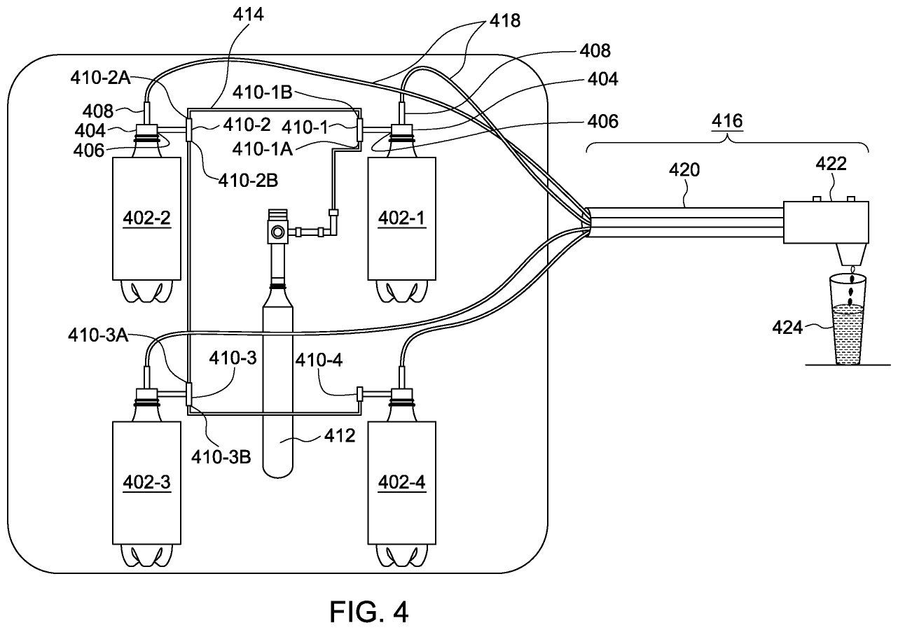

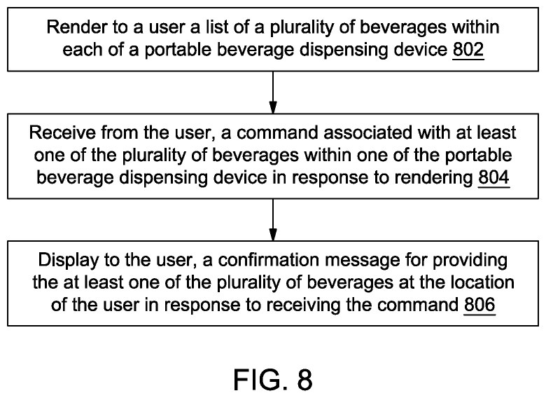

Further, a left side view of the portable beverage dispensing device 102 is depicted. As depicted via the FIG. 1B, the portable beverage dispensing device 102 may also include a dispensing mechanism 116. The dispensing mechanism 116 may be configured to dispense the beverage filled within the beverage bottle. The dispensing mechanism 116 may include a dispensing head and a set of dispensing ports. In an embodiment, a dispensing port from the set of dispensing ports may be connected to the beverage bottle present within each of the set beverage bottle holders via a dispensing tube from a plurality of dispensing tubes. Further, each of the plurality of dispensing tubes of the dispensing mechanism 116 may be connected to each of the cap assembly of each beverage bottle placed inside the potable beverage dispensing device 102 via a port 120. As depicted via the present FIG. 1B, each of the plurality of dispensing tubes may be concealed within an encloser 118 (e.g., insulated cover) to avoid damaging of the plurality of dispensing tubes. The connection of the set of dispensing ports with the cap assembly of the beverage bottle is further explained in detail with FIG. 4. Further, the dispensing mechanism 116 including the dispensing head and the set of dispensing ports is depicted and explained in detail in conjunction with FIG. 8.

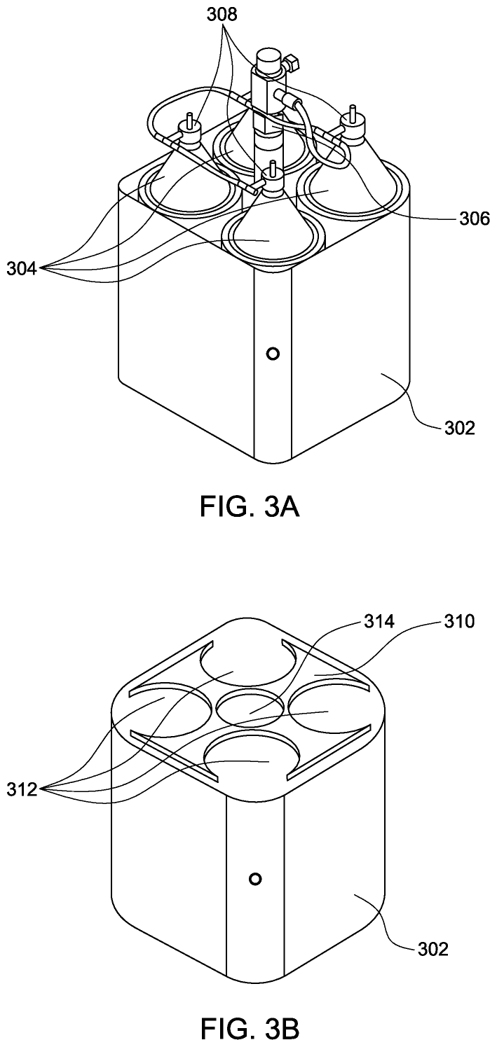

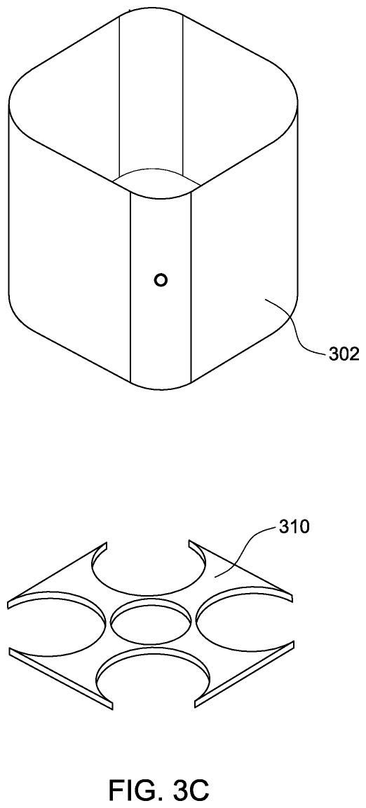

Referring now to FIG. 2A and 2B, a pictorial representation of an inner cavity view and a thermal insulation layer of a portable beverage dispensing device is depicted, in accordance with an exemplary embodiment. FIG. 2A and 2B is explained in conjunction with FIG. 1A and 1B. In the present FIG. 2A, a pictorial representation 200A of the inside view of the portable beverage dispensing device 102 is depicted. The portable beverage dispensing device 102 may be opened by opening a flap 202A of the portable backpack dispensing device 102. By way of an example, the flap 202A of the portable beverage dispensing device 102 may be opened by one of an un-zipping or un-buckling the flap 202A. Further, as depicted via the present FIG. 2A, the portable beverage dispensing device 102 may include a container 204A. The container 204A may further include a plurality of beverage bottles 206A present within the set of beverage bottle holders, and a pressurized gas vessel 208A present within the pressurized gas holder. The container 204A is further depicted and explained detail in conjunction with FIG. 3A-3C.

In FIG. 2B, a pictorial representation 200B of a thermal insulation layer 202B. The thermal insulation layer 202B may be placed between an outer layer 204B and an inner layer 206B. As will be appreciated, the outer layer 204B and the inner layer 206B may be made of a cloth, i.e., a material used for making backpacks (e.g., canvas, nylon, cotton, and the like). By way of an example, when the outer layer 204B and the inner layer 206B may be made of nylon, then the thermal insulation layer 202B may be filled between the outer nylon layer and the inner nylon layer. As will be appreciated, the portable beverage dispensing device 102 may be made by filling the thermal insulation layer 202B between the outer surface 204B and the inner surface 206B of the material used for making the portable beverage dispensing device 102.

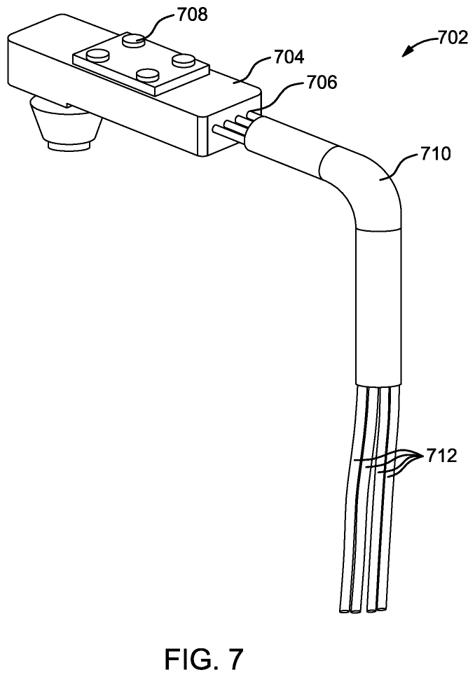

Referring now to FIGS. 3A-3C, a pictorial representation of a container 302 present within a portable beverage dispensing device is depicted, in accordance with an exemplary embodiment. With reference to above FIGS. 1 and 2, the container 302 may correspond to the container 204A. In addition, the portable beverage dispensing device may correspond to the portable dispensing device 102. As depicted via FIG. 3A, the container 302 may include a plurality of beverage bottles 304 (same as the plurality of beverage bottles 206A) and a pressurized gas vessel 306 (same as the pressurized gas vessel 208A), and a plurality of cap assemblies 308. The container 302 may be configured to hold each of the plurality of beverage bottles 304 and the pressurized gas vessel 306. Further, a cap assembly from the plurality of cap assemblies 308 may be configured to fit on an opening of a beverage bottle from the plurality of beverage bottles 304. The cap assembly configured to fit on the opening of the beverage bottle is depicted and explained in detailed in conjunction with FIGS. 7A-7C.

In order to hold the plurality of beverage bottles 304 and the pressurized gas vessel 306, the container 302 may include a lid 310, as depicted via FIG. 3B. The lid 310 may include a set of four beverage bottle holders 312 and a pressurized gas holder 314. Each of the set of four beverage bottle holder 312 may be configured to hold the beverage bottle from the plurality of beverage bottles 304. Further, the pressurized gas holder 314 may be configured to hold the pressurized gas vessel 306. In other words, the lid 310 may include different compartments configured for holding the plurality of beverage bottles 304 and the pressurized gas vessel 306. The pressurized gas vessel 306 is further depicted and explained in greater detail in conjunction with FIG. 6. Further, as depicted via FIG. 3C, the lid 310 may be detachably attached to the container 302. Further, the lid 310 may include air vents for pushing air inside the container 302. As will be appreciated, the air is pushed inside the container 302 via the air vents on the lid 310 to maintain temperature of the beverage filled within the beverage bottles.

Further, with reference to above FIGS. 1 and 2, a bottom portion of the container 302 may include the one or more replaceable cold gel pack. Further, the air may be received from the fan housed within the flap 202A of the portable beverage dispensing device 102. Upon receiving the air from the fan via the air vents on the lid 310, temperature within the container 302 may drop due to the one or more replaceable cold gel packs placed at the bottom of the container 302. This air may be keep circulating within the portable beverage dispensing device 102 to maintain temperature of the beverage filled within each of the plurality of beverage bottles 304.

Referring now to FIG. 4, a connection 400 of a plurality of beverage bottles with a pressurized gas vessel and a dispensing mechanism is illustrated, in accordance with an exemplary embodiment. FIG. 4 is explained in reference to above FIGS. 1-3. As depicted via the present FIG. 4, the plurality of beverage bottles may correspond to a set of four beverage bottles, i.e., a beverage bottle 402-1, a beverage bottle 402-2, a beverage bottle 402-3, and a beverage bottle 402-4. With reference to FIG. 3A, the set of four beverage bottles (402-1, 402-2, 402-3, and 402-4) may correspond to the set of four beverage bottles 304. Each beverage bottle, i.e., 402-1, 402-2, 202-3, and 402-4 may include an associated cap assembly. The cap assembly may include a cork 404 configured to fit on opening of each the beverage bottle 402-1, 402-2, 402-3, and 402-4, as depicted via the present FIG. 4. The cap assembly including the cork that is configured to fit on each of the plurality of beverage bottles is further depicted and explained in greater detail in conjunction with FIGS. 7A-7C.

The cork 404 may include an inlet port 406 and an outlet port 408. In an embodiment, the inlet port 406 of the cork 404 fitted on the opening of each of the set of four beverage bottles (i.e., 402-1, 402-2, 402-3, and 402-4) may be utilized to established connection between each beverage bottle, i.e., 402-1, 402-2, 402-3, and 402-4 and a pressurized gas 412 via a gas tube 414. In an embodiment, the connection between each beverage bottle, i.e., 402-1, 402-2, 402-3, and 402-4 and the pressurized gas vessel may be established to enable flow of the pressurized gas from the pressurized gas vessel 412 to each beverage bottle 402-1, 402-2, 402-3, and 402-4 based on requirement.

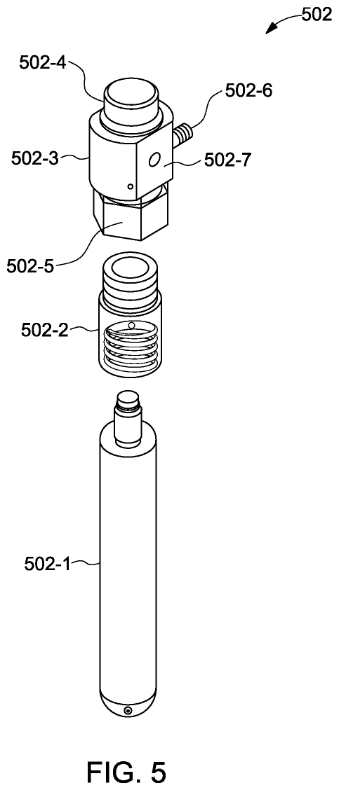

In order to established connection between each beverage bottle, 402-1, 402-2, 402-3, and 402-4 and the pressurized gas vessel 412, the inlet port 406 of each cork 404 fitted on each beverage bottle, i.e., 402-1, 402-2, 402-3, 402-4 may be connected with a T-shaped connector, labelled as 410-1, 410-2, 410-3, 410-4, respectively. Further, as depicted via the present FIG. 4, a first coupling end 410-1A of the T-shaped connector 410-1 may be connected to a pressurized gas vessel 412 (same as the pressurized gas vessel 306) via a gas tube 414. It should be noted that, the pressurized gas vessel 412 may be filled with a pressurized gas, e.g., CO₂ gas. The pressurized gas vessel 412 is further depicted and explained in greater detail in conjunction with FIG. 5. As depicted via the present FIG. 4, the T-shaped connector 410-1 may be connected to the inlet port 406 of the cork 404 fitted on the opening of the beverage bottle 402-1.

Further, a second coupling end 410-1B of the T-shape connector 410-1 may be connected with a first coupling end 410-2A of the T-shaped connector 410-2 via the gas tube 414. As depicted via the present FIG. 4, the T-shaped connector 410-2 may be connected to the inlet port 406 of the cork 404 fitted on the opening of the beverage bottle 402-2. A second coupling end 410-2B of the T-shaped connector 410-2 may be connected to a first coupling end 410-3A of the T-shaped connector 410-3 via the gas tube 414. In an embodiment, as depicted via the present FIG. 4, the T-shaped connector 410-3 may be connected to the inlet port 406 of the cork 404 fitted on the opening of the beverage bottle 402-3. Further, a second coupling end 410-3B of the T-shaped connector 410-3 may be connected to a first coupling end 410-4A of the T-shaped connector 410-4 via the gas tube 414. In an embodiment, as depicted via the present FIG. 4, the T-shaped connector 410-4 may be connected to the inlet port 406 of the cork 404 fitted on the opening of the beverage bottle 410-4. Further, a second coupling end 410-4B of the T-shaped connector 410-4 may be closed using a valve.

Alternatively, the outlet port 408 of the cork 404 fitted on each beverage bottle 402-1, 402-2, 402-3, and 404-4 may be used to establish connection of each beverage bottle (402-1, 402-2, 402-3, and 404-4) with a dispensing mechanism 416 (same as the dispensing mechanism 116). In order to establish connection between each beverage bottle, i.e., 402-1, 402-2, 402-3, and 404-4 with the dispensing mechanism 416, the outlet port 408 of the cork 404 fitted on the beverage bottle 402-1, 402-2, 402-3, 404-4 may be connected to the dispensing mechanism 416 via an associated dispensing tube 418, as depicted via the present FIG. 4. Each dispensing tube 418 associated with each beverage bottle, 402-1, 402-2, 402-3, and 404-4 may be enclosed via an enclosure 420 (same as the enclosure 118). In other words, the dispensing tube 418 associated with each beverage bottle, i.e., 402-1, 402-2, 402-3, and 404-4 may be bundled together into a sleeve, i.e., the enclosure 420. In an embodiment, the enclosure 420 may provide protection and insulation to the dispensing tube 418 associated with each beverage bottle, i.e., 402-1, 402-2, 402-3, and 404-4.

With reference to FIG. 1, the dispensing tube 418 associated with each beverage bottle, 402-1, 402-2, 402-3, and 404-4 that is outside the portable beverage dispensing device 102 may be bundled into the enclosure 420. Further, the dispensing mechanism 416 may include a dispensing head 422. The dispensing head may include a set of dispensing ports (not shown) and a set of dispensing buttons (not shown). In an embodiment, the dispensing tube 418 connecting the outlet port 408 of the cork 404 fitted on each beverage bottle 402-1, 402-2, 402-3, and 404-4 may be connected to a dispensing port from the set of dispensing ports. By way of an example, the dispensing tube 418 connecting the outlet port 408 of the cork 404 fitted on the beverage bottle 402-1 may be connected a first dispensing port from the set of dispensing ports. Similarly, the dispensing tube 418 connecting the outlet port 408 of the cork 404 fitted on the beverage bottle 402-2 may be connected a second dispensing port from the set of dispensing ports. Further, each of the set of dispensing buttons on the dispensing head 422 may be configured to initiate dispensing of the beverage through an associated dispensing port. The dispensing mechanism 416 configured for dispensing the beverage filled within each of the set of four beverage bottles is depicted and explained in greater detail in conjunction with FIG. 8.

Once the connection of each beverage bottle (402-1, 402-2, 402-3, and 404-4) with the pressurized gas vessel 412 and the dispensing mechanism 416 is established, then in order to dispense the beverage from the associated beverage bottle, the associated dispensing button may be activated. Upon activation of the associated dispensing button, the beverage may be released from the outlet port 408 of the associated beverage bottle (for example: the beverage bottle 402-1) to the dispensing port via the dispensing tube 418. Once released the beverage may be dispensed via the associated dispensing port. In addition, the activation of the dispensing button may release pressure from the pressurized gas vessel 412 to the associated beverage bottle. By way of an example, suppose the beverage filled within the beverage bottle 402-2 needs to be dispensed. Then, in order to dispense the beverage filled within the beverage bottle 402-2, the user (e.g., the seller) may activate (e.g., press) the dispensing button (for example: the second dispensing button) from the set of dispensing buttons present on the dispensing head 422.

Upon activation of the second dispensing button, the beverage filled within the beverage bottle 402-2 may start flowing from the outlet port 408 of the cork 404 fitted on the beverage bottle 402-2 to the dispensing port (e.g., a second dispensing port) via the associated dispensing tube 418 and may be dispensed via the second dispensing port in a container 424 (e.g., disposable beverage glass). It should be noted that, the dispensing tube 418 may inserted in the beverage bottle 402-2 such that it reached bottom of the beverage bottle 402-2.

In addition, upon activation of the second dispensing button to dispense the beverage filled within the beverage bottle 402-2, the pressure from the pressurized gas vessel 412 may start flowing to the beverage bottle 402-2 via the gas tube 414 though the T-shaped connector 410-2 connected to the inlet port 406 of the cork 404 fitted on the beverage bottle 402-2. The pressure may be released to maintain fizziness of the beverage filled within the beverage bottle 402-2. It should be noted that, the pressure may flow from the pressurized gas vessel 412 to the beverage bottle 402-2 via the gas tube 414 though the T-shaped connector 410-1 towards the T-shaped connector 410-2. Moreover, a third coupling end 410-1C (not shown), i.e., connected to the inlet port 406 of the cork 404 connected to the beverage bottle 402-1 may remain closed. This is because, the pressure within the beverage bottle 402-1 may be maintained as the first dispensing button associated with the beverage bottle 402-1 may not be activated.

Referring now to FIG. 5, a pictorial representation 500 of a pressurized gas vessel 502 is depicted, in accordance with an exemplary embodiment. With reference to FIG. 4, the pressurized gas vessel 502 may correspond to the pressurized gas vessel 412. The pressurized gas vessel 502 may be filled with the pressurized gas, e.g., CO₂. Further, as depicted via the present FIG. 5, the pressurized gas vessel 502 may include a pressurized gas cylinder 502-1, a vessel outlet 502-2, a pressure regulator 502-3, and a pressure regulator knob 502-4. The pressure regulator 502-3 may further include a regulator inlet port 502-5 and a regulator outlet port 502-6. In addition, a pressure sensor 502-7 is attached to the pressure regulator 502-3.

The pressurized gas cylinder 502-1 may be filled with the pressurized gas, i.e., CO₂. Further, the vessel outlet 502-2 may be attached on top opening of the pressurized gas cylinder 502-1. The vessel outlet 502-2 gets connected to the pressure regulator 502-3 via the regulator inlet port 502-5. The pressure regulator 502-3 may be configured for regulating pressure at the regulator outlet port 502-6. With reference to FIG. 4, the regulator outlet port 502-6 may be connected to the inlet port 406 of the beverage bottle 402-1 via the gas tube 414 through the first coupling end 410-1A of the T-shaped connector 410-1 connected at the inlet port 406 of the cork 404 fitted on the beverage bottle 402-1

The pressure of the pressurized gas filled within the pressurized gas vessel 502 may be adjusted via the pressure regulator knob 502-4. Further, the pressure regulator knob 502-4 may enable flow of the pressure from the pressurized gas cylinder 502-1 to a required beverage bottle from the plurality of beverage bottles (same as the beverage bottles 402-1, 402-2, 402-3, and 402-4). Furthermore, the pressure sensor 502-7 may be configured for continuously monitoring a value of the pressure of the pressurized gas filled within the pressurized gas cylinder 502-1, at the regulator outlet port 502-6. In other words, the pressure sensor 502-7 may be configured to continuously capture data include the value associated with the pressure.

Further, based on monitoring, upon identifying drop in the value of the pressure, the pressure sensor 502-7 may be configured to generate a signal and send the signal to a central controller (same as the central controller 108). The signal may indicate the drop in the pressure of the pressurized gas filled within the pressurized gas cylinder 502-1, at the regulator outlet port. Upon receiving the signal from the pressure sensor 502-7, the central controller 108 may be configured to generate a trigger based on the received signal. In present embodiment, since the signal was related to the drop in the pressure, hence the generated trigger may be a notification for refilling the pressurized gas within the pressurized gas cylinder 502-1.

Referring now to FIG. 6A to 6C, a pictorial representation of a cap assembly 602 configured to fit on a beverage bottle 604 is depicted, in accordance with an exemplary embodiment. In FIG. 6A, the cap assembly 602 and the beverage bottle 604 is depicted. In an embodiment, the beverage bottle 604 may be a soda beverage bottle that is commercially available soda beverage bottles (e.g., Polyethylene terephthalate (PET) bottles filled with soda beverages). Further, the cap assembly 602 may be devised in such a way that it can easily fit on an opening 606 of the beverage bottle 604. As will be appreciated the cap assembly 602 may include a cork (shown in FIG. 6C) configured to fit on the opening 606 of the beverage bottle 604. The beverage bottle 604 with the cap assembly 602 fitted on the opening 606 of the beverage bottle 606 is depicted via FIG. 6B.

The beverage bottle 604 may further include a beverage level sensor 608. As depicted via the present FIG. 6A and 6B, the beverage level sensor 608 may be attached to outer surface of the beverage bottle 604. The beverage level sensor 608 may be configured to monitor level of the beverage filled within the beverage bottle 604. Further, based on monitoring the level of beverage within the beverage bottle 604, the beverage level sensor 608 may be configured to send a signal to a central controller (same as the central controller 108).

The central controller may be configured to generate a trigger based on the received signal (i.e., the level of the beverage). The trigger generated by the controller may be a notification, for example, a notification to replace the beverage bottle 604 with a new beverage bottle, or a notification for insufficient beverage in the beverage bottle 604. With reference to FIG. 4, the beverage bottle 604 may correspond to the set of four beverage bottles, i.e., 402-1, 402-2, 402-3, and 404-4. As will be apricated, the cap assembly 602 depicted in the present FIG. 6 may be attached to each beverage bottle 402-1, 402-2, 402-3, and 404-4. In addition, the beverage level sensor 608 may be attached to the outer surface of each beverage bottle 402-1, 402-2, 402-3, and 404-4.

A detailed view 600C of the cap assembly 602 including different components used for making the cap assembly 602 is depicted via FIG. 6C. As depicted via the present FIG. 6C, the cap assembly 602 may include a cork 602-1. The cork 602-1 may be devised in a way such that it can be fit easily on the opening of the beverage bottle (e.g., the beverage bottle 402-1). As depicted via the present FIG. 6C, the cork 602-1 may include a first end 602-2. The first end 602-2 may include a seal 602-3. The seal 602-3 may include an outlet port 602-4 (same as the outlet port 408). In an embodiment, the seal 602-3 may be an airtight seal. The outlet port 602-4 may be configured to receive a dispensing tube (same as the dispensing tube 418). With reference to FIG. 6B, the dispensing tube may be inserted inside the beverage bottle 604 via the outlet port 602-4. Further, the first end 602-2 may include a tube 602-5 (e.g., a metallic tube or a tube made of rubber or plastic). The dispensing tube may pass through the outlet port 602-3 via the tube 602-5 inside the beverage bottle. Further, the first end 602-2 may be fastened with the cork 602-1 via a set of screws 602-6.

The cork 602-1 may further include an intermediate cylindrical portion 602-7, as depicted via the present FIG. 6C. The intermediate cylindrical portion 602-7 may include an inlet port 602-7. With reference to FIG. 4, the inlet port 602-8 may correspond to the inlet port 406 of the cork 404 configured to fit on each beverage bottle 402-1, 402-2, 402-3, and 402-4. The inlet port 602-8 may be configured to receive the pressurized gas from the pressurized gas vessel (same as the pressurized gas vessel 412) via the gas tube (same as the gas tube 414). In order to receive the pressurized gas, a T-shaped connector 602-9 may be connected to the inlet port 602-8. As depicted via the present FIG. 6C, the T-shaped connector 602-9 may include a first coupling end 602-9A, a second coupling end 602-9B, and a third coupling end 602-9C.

With reference to FIG. 4, when the T-shaped connector 602-9 may correspond to the T-shaped connector 410-1 that is connected with the inlet port 406 of the cork 404 fitted on the beverage bottle 402-1. Then, in this case, the first coupling end 602-9A (same as the first coupling end 410-1A of the T-shaped connector 410-1) may be connected to the pressurized gas vessel 412 via the gas tube 414. Further, the second coupling end 602-9B (same as the second coupling end 410-1B) may be connected with the first coupling end 410-2A of the T-shaped connector 410-2 via the gas tube 414. The T-shaped connector 410-2 may be connected with the inlet port 406 of the cork 404 fitted on the beverage bottle 402-2. Further, the third coupling end 602-9C of the T-shaped connector 602-9 may be connected with the inlet port 602-8.

Furthermore, when the T-shaped connector 602-9 may correspond to the T-shaped connector 410-2 that is connected with the inlet port 406 of the cork 404 fitted on the beverage bottle 402-2. Then, in this case, the first coupling end 602-9A (same as the first coupling end 410-2A of the T-shaped connector 410-2) may be connected to the second coupling end 410-1B of the T-shaped connector 410-1 via the gas tube 414. Further, the second coupling end 602-9B (same as the second coupling end 410-2B) may be connected with the first coupling end 410-3A of the T-shaped connector 410-3 via the gas tube 414. The T-shaped connector 410-3 may be connected with the inlet port 406 of the cork 404 fitted on the beverage bottle 402-3. Further, the third coupling end 602-9C (same as the third coupling end 410-2C) of the T-shaped connector 602-9 (same as the T-shaped connector 410-2) may be connected with the inlet port 602-8 (same as the inlet port 406 of the cork 404 fitted on the beverage bottle 402-2).

The cork 602-1 may further include a second end 602-10. It should be noted that, the intermediate cylindrical portion 602-7 may be positioned between the first end 602-2 and the second end 602-10. Further, as depicted via the present FIG. 6C, the second end 602-10 of the cork 602-1 may include a plurality of grooves and an O-ring (not shown) cooperating with the plurality of grooves. As will be appreciated, the cork 602 may be devised to create an airtight seal at the opening of the beverage bottle 604.

In addition to the cork 602-1, the cap assembly 602 may further include an inner sleeve 602-11 and an outer sleeve 602-12. The second end 602-10 of the cork 602-1 may be attached with the inner sleeve 602-11 via a collar 602-13 (e.g., a shaft collar). The inner sleeve 602-11 may further include a plurality of spherical metal balls 602-14 and a spring 602-15. As depicted via the present FIG. 6C, the plurality of special metal balls 602-14 may be present at bottom end of the inner sleeve 602-11 around its periphery. The inner sleeve 602-11 and the outer sleeve 602-12 may be assembled with each other via the plurality of spherical metal balls 602-14 and the spring 602-15. In an embodiment, the inner sleeve 602-11 and the outer sleeve 602-12 may be assembled with each other in such a way that a circumferential space is created the inner sleeve 602-11 and the outer sleeve 602-12. Further, the outer sleeve 602-12 may be configured to move relative to the inner sleeve 602-11 between a up position and a down position to put the cork 602-1 in a locked state or an unlocked state at the opening of the beverage bottle.

Further, the plurality of the spherical metal balls 602-14 may be configured to move radially between a first position and a second position. In the locked state of the cork 602-1, the plurality of the spherical metal balls 602-14 may be at the first position and the outer sleeve is at the down position. In other words, in order to put the cork 602-1 in the locked state, the outer sleeve 602-12 is pushed down (i.e., the down position) at the opening of the beverage bottle. As will be appreciated, when the outer sleeve 602-12 is pushed down (i.e., at the down position), the plurality of spherical metal balls 602-14 moves inwards, i.e., at the first position (closer to each other) and the circumferential space between the inner sleeve 602-11 and the outer sleeve 602-12 is narrower.

Further, in the unlocked state of the cork 602-1, the plurality of the spherical metal balls 602-14 may be at the second position and the outer sleeve 602-12 may be at the up position. In other words, in order to put the cork 602-1 in the unlocked state, the outer sleeve 602-12 is pulled up (i.e., the up position) at the opening of the beverage bottle. As will be appreciated, when the outer sleeve 602-12 is pulled up (i.e., at the up position), the plurality of spherical metal balls 602-1 may move outwards, i.e., at the second position (apart from each other) and the circumferential space between the inner sleeve 602-11 and the outer sleeve 602-12 may be large. As will be appreciated, the assembling of the inner sleeve 602-11 and 602-12 is done in such a way that the outer sleeve 602-12 may be pulled up (i.e., the up position) to a pre-defined distance.

Referring now to FIG. 7, a pictorial representation of a dispensing mechanism 702 is depicted, in accordance with an exemplary embodiment. With reference to FIG. 4, the dispensing mechanism 702 may include a dispensing head 704 (same as the dispensing head 422). As depicted via the present FIG. 7, the dispensing head 704 may include a set of dispensing ports 706. In an embodiment, a dispensing port from the set of dispensing ports 706 is connected via a dispensing tube (same as the dispensing tube 418) to the outlet port (same as the outlet port 408) of the beverage bottle (same as the 402-1).

In addition to the set of dispensing ports 706, the dispensing head 704 may include a set of dispensing buttons 708. In an embodiment, each of the set of dispensing buttons 708 may be configured to initiate dispensing of a beverage through an associated dispensing port. In order to dispense the beverage through the associated dispensing port, a dispensing button from the set of dispensing buttons 708 associated with the beverage bottle containing the beverage that needs to be dispensed may be activated. By way of an example, the dispensing button may be activated by pressing the dispensing button. Further, the activation of the dispensing button from the set of dispensing buttons may be configured to release pressure from the pressurized gas vessel (same as the pressurized gas vessel 412) into the beverage bottle (402-1) via the inlet port (408).

With reference to FIG. 4, the pressured from the pressurized gas vessel 412 may be released into the beverage bottle 402-1 via a first coupling end 410-1A of the T-shaped connector 410-1 through the gas tube 414. In addition to releasing the pressure, the activation of the dispensing button from the set of dispensing buttons 708 may be configured to release the beverage from the outlet port (same as the outlet port 408) to the dispensing port via the dispensing tube (418). Additionally, the activation of the dispensing button may dispense the beverage from the dispensing port associated with the beverage bottle.

In other words, in order to dispense the beverage filled within the beverage bottle, each of the set of ports 706 may further extend to a pathway from a set of pathways. Further, each of the set of pathways may be closed by a spool connected to each of the set of dispensing buttons 708. Upon activation of the dispensing button from the set of dispensing buttons 708, the spool associated with the pathway of the associated dispensing port may get opened to enable the beverage to flow from the pathway of the associated dispensing port to dispense the beverage.

As depicted via the present FIG. 7, the dispensing tube 712 (same as the dispensing tube 418) associated with each beverage bottle (same as the set of four beverage bottles 402-1, 402-1, 402-3, and 404-4) may be enclosed in an enclosure 710 (same as the enclosure 420). In an embodiment, the enclosure 420 may be outside a portable beverage dispensing device (same as the portable beverage dispensing device 102). As will be appreciated, the enclosure 420 may be an insulated enclosure to avoid damaging of the dispensing tube 712.

Referring now to FIG. 8, a flow diagram of a method for providing beverage at a location of a user is illustrated, in accordance with an embodiment. In order to provide beverage at the location of the user, initially, at step 802, a list of a plurality of beverages within each of a portable beverage dispensing device may be rendered to the user. By way of an example, the plurality of beverages may be carbonated beverage, for example, sparkling water, soft drinks, energy drinks, and the like. In an embodiment, the list of plurality of beverages may be rendered to the user via a user device. Examples of the user device may include but is not limited to, smartphone, laptop, desktop, and tablet. Further, in some embodiment, the list of plurality of beverages may be rendered to the user via an application installed in the user device. The list may include a type of each of the plurality of beverages, an amount of each of the plurality of beverages, and additional attributes associated with each of the plurality of beverages.

The additional attributes associated with each of the plurality of beverages may include temperature (chilled, medium cold, etc.), with ice or without ice, with straw or without straw, and the like. In addition, the location of the user may be within a pre-defined range of each of the portable beverage dispensing device 102. For example, the pre-defined range be defined to be within 10 Kilometers (Kms). Based on the pre-defined range, i.e., 10 Kms, the user may be able to view the list of plurality of beverages present within one or more of the portable beverage dispensing device 102 that may be present within 10 Kms from the user's locations.

Further, at step 804, a command associated with at least one of the plurality of beverages within one of the portable beverage dispensing device 102 may be received from the user in response to rendering. In an embodiment, the command may include a request to provide the at least one of the plurality of beverages at the location of the user and one or more of the additional attributes selected by the user corresponding to at least one of the plurality of beverages. By way of an example, the one or more of the additional attributes selected by the user may be ‘with ice’ and ‘with straw’.

Upon receiving the command, at step 806, a confirmation message for providing the at least one of the plurality of beverages at the location of the user may be displayed to the user, in response to receiving the command. In other words, once a seller carrying the portable beverage dispensing device 102 accepts the request received from the user, then the confirmation message, for example: “order placed” may be displayed to the user. This method of providing the beverage at the location of the user is further explained in detail in conjunction with FIG. 11.

Referring now to FIG. 9, a flowchart of a method for establishing communication for providing beverages at a user location is illustrated, in accordance with an embodiment. In order to provide beverage at the location of the user, initially, at step 902, a server may receive a command. The command may be associated with at least one of a plurality of beverages within at least one of a portable beverage dispensing device available within a pre-defined range of a user location. In an embodiment, the command may include a request to provide the at least one of the plurality of beverages at the user location. In addition, the command may also include one or more additional attributes selected by the user corresponding to the at least one of the plurality of beverages. The additional attributes associated with each of the plurality of beverages may include temperature (e.g., chilled, medium cold, etc.), with ice or without ice, with straw or without straw, and the like.

Upon receiving the command from the user, at step 904, the server may transmit the command associated with the at least one of the plurality of beverages to at least one of the portable beverage dispensing device. In order to transmit the command to the at least one of the portable beverage dispensing device, the server may select at least one of the portable beverage dispensing device present within the pre-defined range of the user based on the command received from the user. By way of example, when the command received from the user for a beverage, for example, a lemonade may be ‘250 ml of five lemonades with ice’. In this example, the request may be 250 ml of five lemonades and the one or more additional attributes selected by the user for the lemonade may be “with ice”. Upon receiving this command, the server may search for the at least one of the plurality of beverage dispensing devices that may be having the requested amount of lemonade. Moreover, the server may search for the at least one of the plurality of beverage dispensing devices within the pre-defined range (for example: 10 kms) from the location of the user. Once the at least one of the plurality of beverage dispensing devices is identified, then the server may transmit the command to the at least one of the plurality of beverage dispensing device.

Further, at step 906, the server may receive a confirmation message from the at least one of the plurality of beverage dispensing devices. The confirmation message may be for providing the at least one of the plurality of beverages at the user location with fulfilment of the one or more of the plurality of attributes. By way of an example: the confirmation message may be “order placed”. This confirmation message may be received by the server, when the seller carrying the at least one of the portable beverage dispensing device may accept the request received from the server. Once the server receives the confirmation message from the at least one of the portable beverage dispensing device, then at step 908, the server may transmit the confirmation message to a user device.

Referring now to FIG. 10, an exemplary environment diagram 1000 for providing beverage at a location of a user 1002 is illustrated, in accordance with an exemplary embodiment. In an embodiment, the user 1002 may be a customer who may be interested in ordering the beverage (for example: a soft drink) at his location (for example: home). In order to order the soft drink, initially, the user 1002 may open an application installed on his user device. Examples of the user device may include, but is not limited to, smartphone, laptop, tablet, and desktop. Upon opening the application, a list of a plurality of beverages within each of a portable beverage dispensing devices. The list of the plurality of beverages may include the amount of each of the plurality of beverages, and additional attributes associated with each of the plurality of beverages. By way of an example, the additional attributes associated with each of the plurality of beverages may include, but is not limited to, temperature (chilled, medium cold, etc.), with ice or without ice, with straw or without straw, and the like.

In an embodiment, each of the plurality of beverage dispensing devices may be present with a pre-define range from the location of the user 1002. In other words, each person (i.e., a seller) carrying the portable beverage dispensing device may be within the pre-defined range from the location of the user 1002. It should be noted that for each of explanation, one seller 1004 carrying the portable dispensing device 1006 is depicted via the present FIG. 10. By way of an example, the seller 1004 may be present within 5 kms (pre-defined range) from the home of the user 1002.

Further, based on the rendered list of the plurality of beverages, the user 1002 may select the soft drink that he would like to order. By way of an example, suppose the user 1002 may select the soft drink, e.g., ‘Pepsi’. Further, in addition to the selection of the soft drink, the user 1002 may select one or more additional attributes. For example, the user 1002 may select amount, e.g., 500 ml of the soft drink and with ‘ice’ attributes. Further, once the user 1002 has selected the soft drink and the one or more attributes, the user 1002 may click on ‘a place order’ button displayed to the user 1002 via the application installed one his user device to place his order.

Once the order is placed by the user 1002, a command may be sent to a server 1008 via a network 1012. The command may include a request to provide the at least one of the plurality of beverages at the location, i.e., his home) of the user 1002 and one or more of the additional attributes (i.e., the 500 ml of Pepsi with ice) selected by the user 1002 corresponding to at least one of the plurality of beverages. The network 1012, for example, may be any a wireless communication network and the examples may include, but may be not limited to, the Internet, Wireless Local Area Network (WLAN), Wi-Fi, Worldwide Interoperability for Microwave Access (WiMAX), and General Packet Radio Service (GPRS).

The server 1008 may further include a database 1010. The database 1010 may be configured to store information about each seller 1004 carrying the portable beverage dispensing device 1006. By way of an example, the information associated with the seller 1006 may include name, location, beverages with his portable beverage dispensing device, and the like. Further, the database 1010 may be periodically updated based on information associated with previous sellers or information associated with a new seller.

Upon receiving the command from the user 1002 via the user device through the network 1012, the server 1008 may be configured to transmit the command associated with the at least one of the plurality of beverages, i.e., ‘500 ml of Pepsi with ice’ to at least one of the portable beverage dispensing devices via the network 1012. As will be appreciated, the server 1008 may search for a suitable portable beverage dispensing device based on the command received from the user 1002. By way of an example, in order to search for the suitable beverage dispensing device, the server 1008 may look for the portable beverage dispensing device that may be fulfill the command received from the user and present within the pre-defined range (e.g., 5 kms) from the location, i.e., the home of the user 1002. For example, with respect to present FIG. 10, the suitable beverage dispensing device selected by the server 1008 may be the portable beverage dispensing device 1006. Once the command is transmitted to the portable beverage dispensing device 1006, the seller 1004 may accept the command received from the server 1008. In some embodiment, if the seller 1004 of the portable beverage dispensing device 1006 rejects the command, then the server 1008 may search for another suitable portable beverage dispensing device within the pre-defined range of the user 1002.

With reference to FIG. 1, the command may be transmitted by the server 1008 to a communication system (same as the communication system 104) of the portable beverage dispensing device 1006 (same as the portable beverage dispensing device 102). Further, the seller 1004 may accept or reject the received command via his user device (e.g., smartphone) connected to the communication system or via touch screen display of the communication system. For example, the communication system of the portable beverage dispensing device 1006 may be connected with the user device of the seller 1004 via a Bluetooth connection. Once the request is accepted by the seller 1004 of the portable dispensing device 1006, a confirmation message for providing requested beverage, i.e., the ‘500 ml of Pepsi’ at the user location (i.e., the home) with fulfilment of the one or more of additional attributes may be sent via the communication system to the server 1008 through the network 1012. Upon receiving the confirmation message, the server 1008 may transmit the confirmation message to the user device of the user 1002 through the network 1012.

Various embodiments provide a portable beverage dispensing device and method thereof. The disclosed portable beverage dispensing device may include a container and a dispensing mechanism. The container may further include a set of beverage holders, a pressurized gas holder, and a plurality of cap assemblies. Each of the set of beverage holders may be configured to hold a beverage bottle. The pressurized gas holder may be configured for holding a beverage bottle. Further, a cap assembly from the plurality of assemblies may include a cork configured to fit on an opening of the beverage bottle. The cork may further include an inlet port and an outlet port. The inlet port may be connected via a gas tube to the pressurized gas vessel and configured to receive the pressurized gas from the pressurized gas vessel into the beverage bottle. The outlet port may be configured for dispensing a beverage filled within the beverage bottle in response to receiving the pressurized gas. The dispensing mechanism may be configured to dispense the beverage filled within the beverage bottle. The dispensing mechanism may include a dispensing head. The dispensing head may further include a set of dispensing ports and a set of dispensing buttons. A dispensing port from the set of dispensing ports may be connected via a dispensing tube to the outlet port of the beverage bottle. The set of dispensing buttons may be configured to initiate dispensing of a beverage through an associated dispensing port. Further, activation of a dispensing button from the set of dispensing buttons may be configured to release pressure from the pressurized gas vessel into the beverage bottle via the inlet port, release the beverage from the outlet port to the dispensing port via the dispensing tube, and dispense the beverage from the dispensing port.

The disclosed portable beverage dispensing device and method may provide some advantages like, the disclosed portable beverage dispensing device may maintain temperature and fizziness of the beverage filled within the beverage bottle present with the portable beverage dispensing device. Further, the disclosed portable beverage dispensing device may be an insulated material (i.e., the thermal insulation layer) that prevents the beverage from rapidly heating. Moreover, since the disclosed portable beverage dispensing device is a portable backpack, hence it can be easily carried by the seller at a consumer site of consumption. In addition, the disclosed portable beverage dispensing device includes an in-built communication system that may keep seller update with respect to level of beverage within the beverage bottles, level of pressurized gas in the pressurized gas vessel, and the like, by generating corresponding triggers.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A portable beverage dispensing device comprising:
a container comprising:
a set of beverage holders, wherein each of the set of beverage holders is configured to hold a beverage bottle;
a pressurized gas holder configured for holding a pressurized gas vessel filled with a pressurized gas;
a plurality of cap assemblies, wherein a cap assembly from the plurality of assemblies comprises a cork configured to fit on an opening of the beverage bottle, wherein the cork comprises:
an inlet port connected via a gas tube to the pressurized gas vessel and configured to receive the pressurized gas from the pressurized gas vessel into the beverage bottle;
an outlet port for dispensing a beverage filled within the beverage bottle in response to receiving the pressurized gas; and
a dispensing mechanism configured to dispense the beverage filled within the beverage bottle, wherein the dispensing mechanism comprises:
a dispensing head comprising:
a set of dispensing ports, wherein a dispensing port from the set of dispensing ports is connected via a dispensing tube to the outlet port of the beverage bottle; and
a set of dispensing buttons configured to initiate dispensing of a beverage through an associated dispensing port, wherein activation of a dispensing button from the set of dispensing buttons is configured to:
release pressure from the pressurized gas vessel into the beverage bottle via the inlet port;
release the beverage from the outlet port to the dispensing port via the dispensing tube; and
dispense the beverage from the dispensing port.

2. The portable beverage dispensing device of claim 1, further comprising a communication system comprising:
an interactive display configured to display attributes associated with beverage present within the beverage bottle;
a communication module configured to receive commands from a user corresponding to the beverage present within the beverage bottle, wherein the communication module receives command from the user present within a pre-defined range, for providing the beverage at a location of the user, via the user device;
a plurality of sensors configured to generate a signal based on a data captured by each of the plurality of sensors; and
a central controller coupled to the interactive display, the communication module, and the plurality of sensors, wherein the central controller is configured to:
receive the generated signal form each of the plurality of sensors, wherein the central controller is configured for generating a trigger based on the received signal; and
perform an action based on the command received from the user corresponding to the beverage present within the beverage bottle.

3. The portable beverage dispensing device of claim 2, wherein the plurality of sensors comprises a set of pressure sensors, a set of beverage level sensors, and a set of temperature level sensors.

4. The portable beverage dispensing device of claim 2, wherein the trigger comprises at least one of: replace the beverage bottle, re-fill the pressurized gas in the pressurized gas vessel, change at least one of the one or more replaceable cold gel packs, and rise in temperature of the beverage filled within the beverage bottle.

5. The portable beverage dispensing device of claim 1, further comprising a cooling mechanism configured to maintain temperature of beverage filled within the beverage bottle, wherein the cooling mechanism comprises an insulation sheet for insulating the container, a fan, and one or more replaceable cold gel packs.

6. The portable beverage dispensing device of claim 1, further comprising:
a portable backpack covering an outer surface of the container, wherein the portable backpack comprises a thermal insulation layer configured to create a thermal insulated cavity inside the portable backpack to thermally insulate the container.

7. The portable beverage dispensing device of claim 1, wherein each of the set of dispensing ports comprises a spool connected to each of the set of dispensing buttons configured for opening one of the set of dispensing ports upon actuation of a corresponding dispensing button from the set of dispensing buttons.

8. A cap assembly for beverage bottles, the cap assembly comprising:
a cork comprising:
a first end comprising:
an outlet port configured to:
receive a tube; and
dispense, via the tube, a beverage from within a beverage bottle;
an intermediate cylindrical surface comprising:
an inlet port configured to receive a pressurized gas from a pressurized gas vessel via a gas tube;
a second end, wherein the intermediate cylindrical surface is positioned between the first end and the second end, and wherein the second end comprises a plurality of grooves, and 0-rings cooperating with the plurality of grooves;
an inner sleeve, wherein the second end of the cork is attached to the inner sleeve via a collar, wherein the inner sleeve comprises a plurality of spherical metal balls and a spring; and
an outer sleeve, wherein the inner sleeve and the outer sleeve are assembled with each other via the plurality of spherical metal balls and the spring, and wherein the outer sleeve is configured to move relative to the inner sleeve between a up position and a down position to put the cork in a locked state or an unlocked state at an opening of the beverage bottle.

9. The cap assembly of claim 8, wherein the plurality of the spherical metal balls is configured to move radially between a first position and a second position, and wherein, in the locked state, the plurality of the spherical metal balls is at the first position and the outer sleeve is at the down position, and wherein, in the unlocked state, the plurality of the spherical metal balls is at the second position and the outer sleeve is at the up position.

10. The cap assembly as claimed in claim 8, wherein the outlet port of the cork comprises an airtight seal for inserting the dispensing tube into the beverage bottle.

11. A method for providing beverage at a location of a user, the method comprising:
rendering to a user, via a user device, a list of a plurality of beverages within each of a portable beverage dispensing device, wherein the list comprises a type of each of the plurality of beverages, an amount of each of the plurality of beverages, and additional attributes associated with each of the plurality of beverages, and wherein the location of the user is within a pre-defined range of each of the portable beverage dispensing device;
receiving from the user, via the user device, a command associated with at least one of the plurality of beverages within one of the portable beverage dispensing device in response to rendering, wherein the command comprises a request to provide the at least one of the plurality of beverages at the location of the user and one or more of the additional attributes selected by the user corresponding to at least one of the plurality of beverages; and
displaying to the user, via the user device, a confirmation message for providing the at least one of the plurality of beverages at the location of the user in response to receiving the command.

12. A method for establishing communication for providing beverages at a user location, the method comprising:
receiving, by a server, a command associated with at least one of a plurality of beverages within at least one of a portable beverage dispensing device available within a pre-defined range of a user location, wherein the command comprises a request to provide the at least one of the plurality of beverages at the user location and one or more additional attributes selected by the user corresponding to the at least one of the plurality of beverages;
transmitting, by the server to at least one of the portable beverage dispensing device, the command associated with the at least one of the plurality of beverages;
receiving, by the server from the at least one of the portable beverage dispensing device, a confirmation message for providing the at least one of the plurality of beverages at the user location with fulfilment of the one or more of the additional attributes; and
transmitting, by the server, the confirmation message to a user device.
